(19) United States
(12) Patent Application Publication
(10) Pub. No.: US 2013/0122608 A1
(43) Pub. Date: May 16, 2013

(54) Method for Estimating Binding Kinetic Rate Constants by Using Fiber Optics Particle Plasmon Resonance (FOPPR) Sensor

(71) Applicants: SHAU-CHUN WANG, Chiayi City (TW); LAI-KWAN CHAU, Chiayi City (TW); TING-CHOU CHANG, Dounan Township (TW); CHAO-CHING WU, Kaohsiung City (TW)

(72) Inventors: SHAU-CHUN WANG, Chiayi City (TW); LAI-KWAN CHAU, Chiayi City (TW); TING-CHOU CHANG, Dounan Township (TW); CHAO-CHING WU, Kaohsiung City (TW)

(73) Assignee: NATIONAL CHUNG CHENG UNIVERSITY, Minhsiung Township (TW)

(21) Appl. No.: 13/470,984

(22) Filed: May 14, 2012

(30) Foreign Application Priority Data
Nov. 14, 2011 (TW) 100141527

(51) Int. Cl. G01N 21/55

(52) U.S. Cl. 436/517; 436/34

(57) ABSTRACT

A method for estimating binding kinetic rate constants by using a fiber optic particle plasmon resonance (FOPPR) sensor mainly employs the steps of: providing a FOPPR sensor instrument system, obtaining optical signal intensities at an initial time and steady state signal intensities of first and second regions in an intensity versus time graph separately, substituting the measured signal intensity values into a formula derived by using a pseudo-first order rate equation model. According to this method, no fluorophore labeling is required. In addition, this method measures a temporal signal intensity evolution under static conditions as the samples are quickly loaded. As a result, unlike the conventional device where the sample is continuously infused, the method is able to measure binding and decomposition rate constants whose upper limit is not limited by a sample flow rate.

### CROSS-REFERENCE TO RELATED APPLICATION

This application claims the benefit of Taiwan Patent Application No. 100141527, filed on Nov. 14, 2011, in the Taiwan Intellectual Property Office, the disclosure of which is incorporated herein by reference.

### FIELD OF THE INVENTION

The present invention relates to a method for estimating binding kinetic rate constants by using a fiber optics particle plasmon resonance (FOPPR) sensor, in particular to the method for estimating binding kinetic rate constants by using a FOPPR sensor that provides a very simple, easy, and quick binding kinetic rate constants estimation process.

### BACKGROUND OF THE INVENTION

Chemical thermodynamics is the study of chemical reactions with respect to the balanced nature and mainly concerns the initial and final states of the chemical reactions. Chemical kinetics is the study of chemical reactions with respect to reactions rates, and generally applied in related studies and discussions of the binding ability of biological molecules. The affinity constant k_{f}, the binding rate constant kₐ and the decomposition rate constant k_{d} are major parameters of chemical kinetics. As to the chemical kinetics of the biological molecules, the binding rate constant represents the rate of forming a molecular complex, and the decomposition rate constant represents the stability of the molecular complex.

Biosensor is a device used for testing and analyzing chemical compounds, while having the functions of monitoring the variance of a chemical reaction, and converting the variance into a specific signal for a convenient observation. Related chemical kinetics researches can be conducted by observing the specific signals. For example, the value of a specific signal can be used for calculating the decomposition rate constant or binding rate constant in the chemical kinetics.

However, the aforementioned biosensor adopts a fluorescent fluorophore labeling mechanism for labeling a substance to be tested, and thus affecting the properties of the substance to be tested. In addition, present existing plasmon resonance sensors (such as Biacore systems) usually come with a design of injecting and flowing a solution to be tested, so that the measured upper limit of the binding rate constant kₐ and the decomposition rate constant k_{d} is restricted by the flow rate of the injected solution to be tested. The aforementioned problems are technical issues remain to be solved.

### SUMMARY OF THE INVENTION

In view of the shortcomings of the prior art, the inventor of the present invention based on years of experience in the related industry to conduct extensive researches and experiments, and finally developed a method for estimating binding kinetic rate constants by using a fiber optics particle plasmon resonance sensor in order to overcome the aforementioned shortcomings of the prior art.

Therefore, it is a primary objective of the present invention to provide a method for estimating binding kinetic rate constants in a simple, convenient and quick manner by using a fiber optics particle plasmon resonance (FOPPR) sensor.

Another objective of the present invention is to provide a method for estimating binding kinetic rate constants by using a fiber optics particle plasmon resonance sensor without adopting any fluorophore labeling mechanism for labeling the substance to be tested.

A further objective of the present invention is to provide a method for estimating binding kinetic rate constants by using a fiber optics particle plasmon resonance sensor, and the method can estimate the kinetics constants simply by a signal intensity value corresponding to the initial time of the reaction.

To achieve the aforementioned objective, the present invention provides a method for estimating binding kinetic rate constants by using a fiber optics particle plasmon resonance sensor, and the method comprises the steps of:

providing the FOPPR sensor that comprises: a light source, emitting a light; a light receiver; and an optical-fiber sensor chip, disposed between the light source and the light receiver, and comprising: an optical fiber, divided into a first region and a second region, and the first region being disposed on both corresponding opposite sides of the second region, and the first region having a fiber core, a clad and a protective layer arranged sequentially from inside to outside, and the fiber core being made of a material with an index of refraction greater than the index of refraction of the clad, such that the light travels in the fiber core, and the second region having the fiber core, the clad, a nanoparticle layer and a testing layer arranged sequentially from inside to outside; a first plate, having a groove, provided for disposing the optical fiber; and a second plate, having a first tube and a second tube longitudinally disposed on a side of the second plate, and the first tube being hollow and having a first opening, and the second tube being hollow and having a second opening, and the first tube and the second tube interconnected to the second plate, and another side of the second plate different from the side having the first tube and the second tube corresponding to the first plate face to face with each other, such that the optical fiber disposed between the first plate and the second plate, and the optical fiber is disposed correspondingly in the groove of the first plate, and the second plate is disposed corresponding to the first plate face to face with each other and packaged;

turning on the light source of the FOPPR sensor, so that the light enters into the optical fiber of the optical-fiber sensor chip, and the light is fully reflected to travel in the fiber core, and the light receiver of the FOPPR sensor starting for receiving a light signal;

filling a first solution to be tested into the first tube from the first opening that serves as an inlet, such that the first solution to be tested flows from the first tube into the optical-fiber sensor chip, and the first solution to be tested having a first concentration C₁, and filling a second solution to be tested into the first tube from the first opening that serves as an inlet, such that the second solution to be tested flows from the first tube into the optical-fiber sensor chip, and the second solution to be tested having a second concentration C₂;

converting the light signal received by the light receiver into a time versus signal intensity value graph through the FOPPR sensor, and the curve in the graph being divided into a first region and a second region, and the first region having a signal intensity value generated by the first solution to be tested, and the second region having a signal intensity value generated by the second solution to be tested;

obtaining signal intensity values I₁ and I₂ of the first region and the second region corresponding to the initial reaction time from the graph respectively, and signal intensity values T_{eq1} and T_{eq2} and a reference light signal intensity I₀ when the reaction in the first region and the second region reaches a dynamic balance;

substituting the signal intensity value obtained at an initial state after filling up the first solution to be tested or the second solution to be tested in the first tube and at a steady state formula ln [(Iₜ−I_{eq})/(I₀−I_{eq})] to calculate a plurality of fractional logarithm values, and perform a linear regression of the time by using the fractional logarithm values to obtain a first linear graph corresponding to the first region and a second linear graph corresponding to the second region;

obtaining a first slope S₁ of a straight line in the first linear graph and a second slope S₂ of a straight line in the second linear graph; and substitute the first slope S₁, the second slope S₂, the first concentration C₁ and the second concentration C₂ into a first equation kₐC₁+k_{d}=S₁ and a second equation kₐC₂+k_{d}=S₂ to obtain a binding rate constant ka by the first equation and the second equation.

The present invention requires no fluorophore labeling mechanism for labeling the substance to be tested, so that the properties of the substance to be tested will not be affected. In addition, the present invention fills the solution to be tested quickly and then measure a change of the light signal intensity with time at a steady state. Unlike the conventional continuous flowing plasmon resonance sensor (such as a Biacore system), the flow rate of the present invention will not restrict the upper limit of the binding rate constant kₐ and decomposition rate constant k_{d} during their measurement.

### BRIEF DESCRIPTION OF THE DRAWINGS

FIG. 1 is a schematic perspective view of a FOPPR sensor used in a method for estimating binding kinetic rate constants;

FIG. 2 is an exploded view of an optical-fiber sensor chip of an FOPPR sensor in accordance with the present invention;

FIG. 3A is a cross-sectional side view of a first region of an optical fiber of an optical-fiber sensor chip in accordance with the present invention;

FIG. 3B is a cross-sectional side view of a second region of an optical fiber of an optical-fiber sensor chip in accordance with the present invention;

FIG. 4A is a part of a flow chart of a method for estimating binding kinetic rate constants by using a fiber optics particle plasmon resonance sensor in accordance with the present invention;

FIG. 4B is another part of a flow chart of a method for estimating binding kinetic rate constants by using a fiber optics particle plasmon resonance sensor in accordance with the present invention;

FIG. 5 is a graph of using OVA as a testing layer and anti-OVA as a solution to be tested for a method of estimating binding kinetic rate constants in accordance with the present invention;

FIG. 6A is a first linear graph of using OVA as a testing layer and anti-OVA as a solution to be tested for a method of estimating binding kinetic rate constants in accordance with the present invention;

FIG. 6B is a second linear graph of using OVA as a testing layer and anti-OVA as a solution to be tested for a method of estimating binding kinetic rate constants in accordance with the present invention;

FIG. 7 is a data chart of binding rate constants (kₐ) and decomposition rate constants (k_{d}) obtained by using OVA as a testing layer and anti-OVA as a solution to be tested in a method for estimating binding kinetic rate constants in accordance with the present invention;

FIG. 8 is a graph of a method that uses a mouse IgG as a testing layer and an anti-mouse IgG as a solution to be tested to estimate binding kinetic rate constants in accordance with the present invention;

FIG. 9A is a first linear graph of a method that uses a mouse IgG as a testing layer and an anti-mouse IgG as a solution to be tested to estimate binding kinetic rate constants in accordance with the present invention;

FIG. 9B is a second linear graph of a method that uses a mouse IgG as a testing layer and an anti-mouse IgG as a solution to be tested to estimate binding kinetic rate constants in accordance with the present invention;

FIG. 10 is a data chart of the binding rate constants (kₐ) the and decomposition rate constants (k_{d}) obtained by using a method that uses a mouse IgG as a testing layer and an anti-mouse IgG as a solution to be tested to estimate binding kinetic rate constants in accordance with the present invention the present invention; and

FIG. 11 is a schematic view of a performing a binding action of a solution to be tested and a testing layer.

### DESCRIPTION OF THE PREFERRED EMBODIMENTS

The technical characteristics of the present invention will become apparent with the detailed description of the preferred embodiments accompanied with the illustration of related drawings as follows. It is noteworthy that same numerals are used for representing the same respective elements in the drawings.

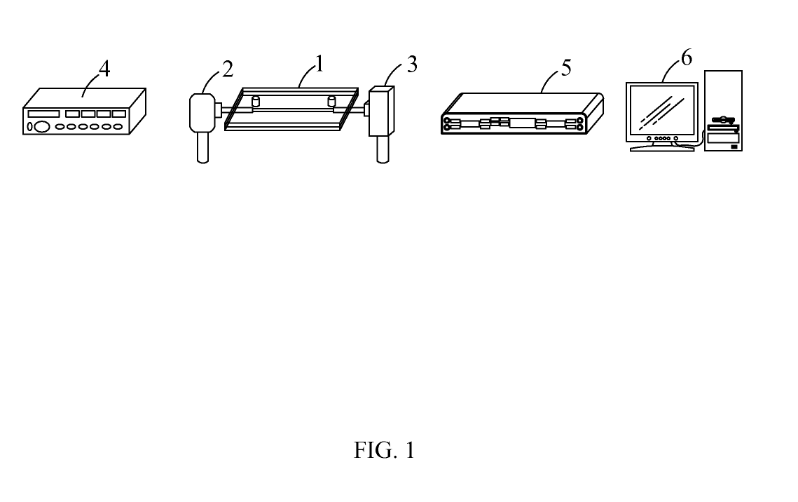

With reference to FIG. 1 for a schematic perspective view of a fiber optics particle plasmon resonance (FOPPR) sensor used in a method for estimating binding kinetic rate constants in accordance with the present invention, the FOPPR sensor comprises an optical-fiber sensor chip 1, a light source 2 and a light receiver 3. The optical-fiber sensor chip 1 is disposed between the light source 2 and the light receiver 3. The light source 2 is a single-frequency light such as a laser or a narrowband light such as a light emitting diode.

The FOPPR sensor of the present invention further selectively comprises a signal waveform generator 4, a lock-in amplifier 5 and a computer 6. The signal waveform generator 4 is installed on a side different from a side having the optical-fiber sensor chip 1 of the light source 2. The lock-in amplifier 5 is installed on a side different from a side having the optical-fiber sensor chip 1 of the light receiver 3. The computer 6 is installed on a side different from a side having the light receiver 3 of the lock-in amplifier 5. The signal waveform generator 4 is provided for generating a square wave of a constant frequency to the light source 2, and a reference signal to the lock-in amplifier 5. The lock-in amplifier 5 receives the light signal from the light receiver 3 and processes the light signal and the reference signal to generate a processed signal. The computer 6 receives the processed signal of the lock-in amplifier 5 and displays the processed signal for reading. The signal waveform generator 4 and the lock-in amplifier 5 are provided for enhancing the signal-to-noise ratio (S/N ratio) of the light signal.

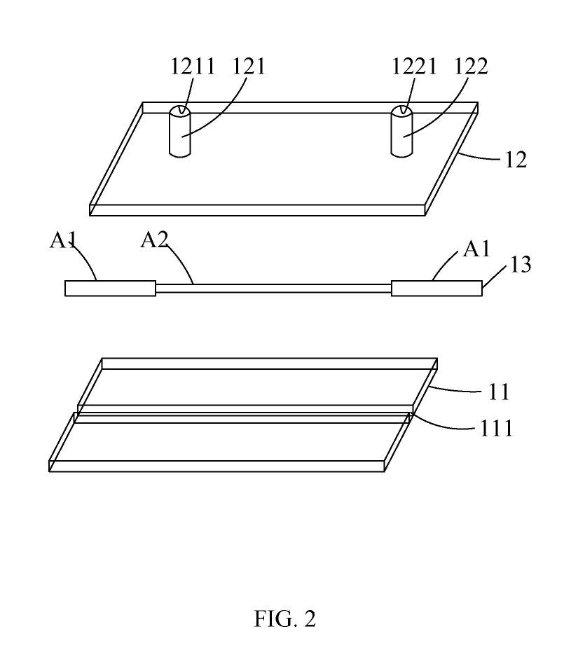

With reference to FIG. 2 for an exploded view of an optical-fiber sensor chip of an FOPPR sensor in accordance with the present invention, the optical-fiber sensor chip comprises a first plate 11, a second plate 12 and an optical fiber 13. The first plate 11 has a groove 111 provided for receiving the optical fiber 13 therein. The second plate 12 has a first tube 121 and a second tube 122 installed longitudinal on a side of the second plate 12, and the first tube 121 is hollow and has a first opening 1211. Similarly the second tube 122 is hollow and has a second opening 1221. The first tube 121 and the second tube 122 are interconnected to the second plate 12. The second plate 12 corresponds to the first plate 11 face to face with a side different from the side having the first tube 121 and second tube 122, such that the optical fiber 13 is disposed between the first plate 11 and the second plate 12. If the optical fiber 13 is placed into the groove 111 of the first plate 11, and the second plate 12 and the first plate 11 are disposed face to face to each other and packaged, the assembly of an optical-fiber sensor chip 1 is completed (as shown in FIG. 1). The first plate 11 or second plate 12 is such as a plastic plate.

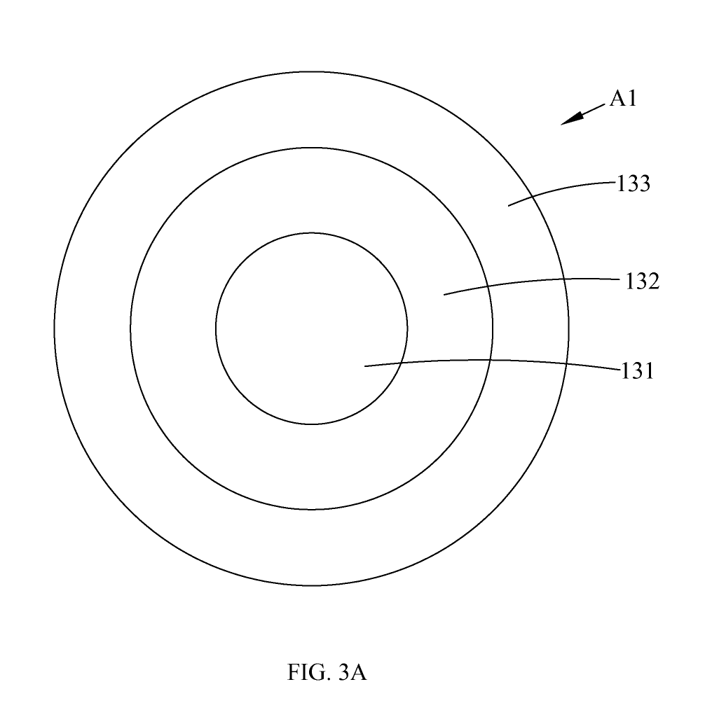

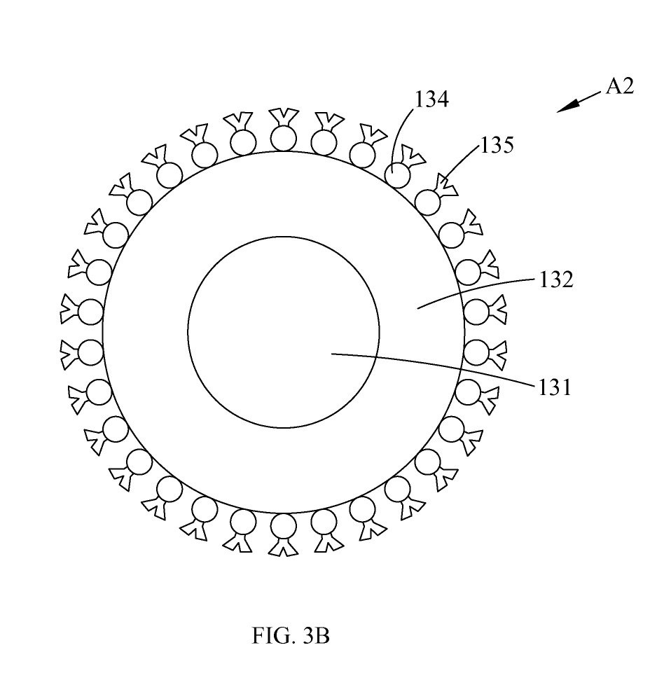

With reference to FIG. 3A for a cross-sectional side view of a first region of an optical fiber of an optical-fiber sensor chip in accordance with the present invention, the optical fiber 13 is divided into a first region A₁ and a second region A₂. The first region A₁ is disposed on both corresponding sides of the second region A₂. In the present invention, a fiber core 131, a clad 132 and a protective layer 133 are arranged sequentially from inside to outside of the first region A₁ of the optical fiber 13. The fiber core 131 is such as made of silicon dioxide. The clad 132 is such as made of a polymer material. The fiber core 131 is made of a material having an index of refraction greater than the index of refraction of the clad 132, such that the light can be fully reflected to travel inside the fiber core 131.

With reference to FIG. 3B for a cross-sectional side view of a second region of an optical fiber of an optical-fiber sensor chip in accordance with the present invention, a fiber core 131, a clad 132, a nanoparticle layer 134 and a testing layer 135 are arranged sequentially from inside to outside of the second region A₂ of the optical fiber 13 of the present invention. The fiber core 131 is such as made of silicon dioxide. The clad 132 is such as made of a polymer material. The fiber core 131 is made of a material having an index of refraction greater than the index of refraction of the clad 132. The nanoparticle layer 134 is such as made of nano gold or nano silver. The nanoparticle layer 134 is comprised of a plurality of noble metal nanospheres, a plurality of noble metal nanotubes or a plurality of noble metal nanoshells. The nanoparticle layer 134 can have various different identifying units on a surface of the nanoparticle layer 134 for producing the testing layer 135. The testing layer 135 can be made of an antibody such as anti-mouse IgG, an antigen such as ovalbumin (OVA), a lectin, a hormone receptor, a nucleic acid or a saccharide, and the testing layer 135 is provided for sensing the antigen, cytokine, antibody, hormone, growth factor, neuropeptide, hemoglobin, plasma protein, nucleic acid, carbohydrate, glycoprotein, fatty acid, phosphatidic acid, sterol, antibiotic or toxin. For the illustration purpose, the nanoparticle layer 134 and the testing layer 135 are enlarged and not drawn according to their actual size.

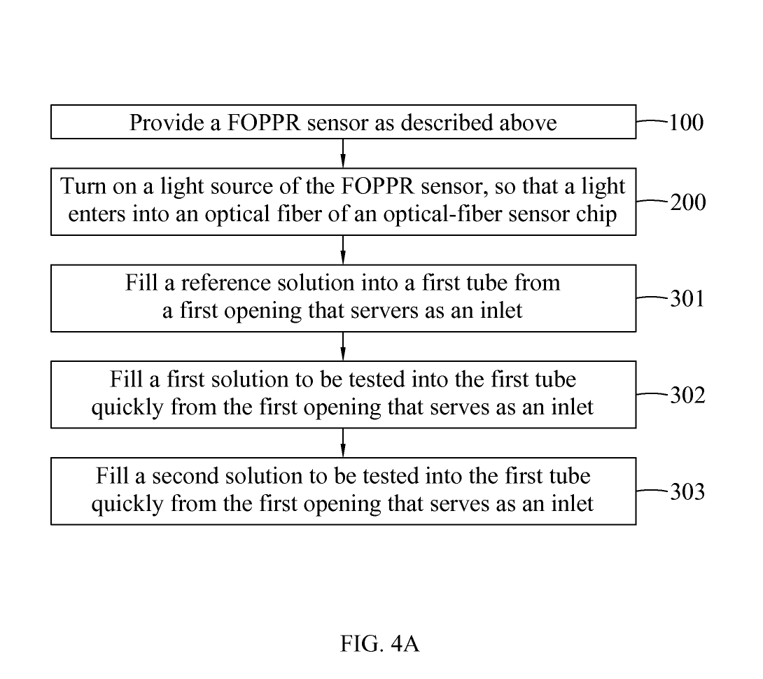

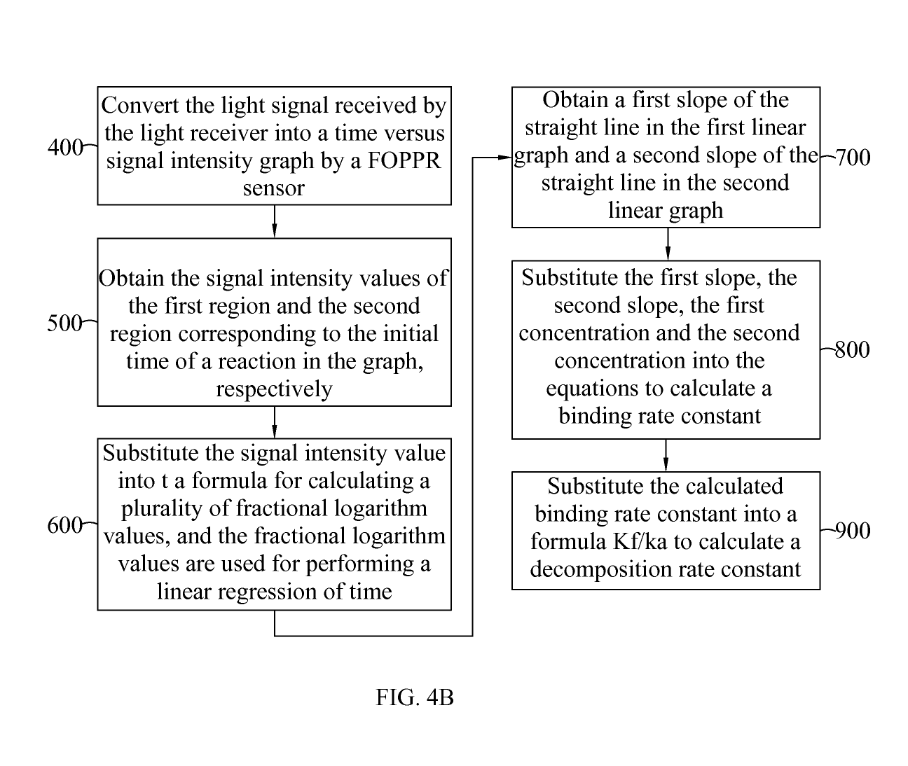

With reference to FIG. 4 for a flow chart of a method for estimating binding kinetic rate constants by using a fiber optics particle plasmon resonance sensor in accordance with the present invention, the method of estimating the binding kinetic rate constants comprises the following steps:

Step 100: Provide a FOPPR sensor as described above.

Step 200: Turn on a light source 2 of the FOPPR sensor, so that a light enters into an optical fiber 13 of an optical-fiber sensor chip 1, and the light will be fully reflected to travel inside a fiber core 131, and a light receiver 3 of the FOPPR sensor starts receiving a light signal.

Step 301: Fill a reference solution into a first tube 121 from a first opening 1211 that servers as an inlet, wherein the reference solution is such as de-ionized water.

Step 302: Fill a first solution to be tested into the first tube 121 quickly from the first opening 1211 that serves as an inlet, such that the first solution to be tested flows from the first tube 121 into the optical-fiber sensor chip 1. The first solution to be tested has a first concentration C₁, and a filling time of 10 seconds.

Step 303: Fill a second solution to be tested into the first tube 121 quickly from the first opening 1211 that serves as an inlet, such that the second solution to be tested flows from the first tube 121 into the optical-fiber sensor chip 1. The second solution to be tested has a second concentration C₂ greater than the first concentration C₁, and a filling time of 10 seconds.

Step 400: Convert the light signal received by the light receiver 3 into a signal intensity versus time graph, time versus signal intensity graph, by a FOPPR sensor, and the curve in the graph is divided into a first region B₁ and a second region B₂, and the first region B₁ represents a signal intensity value produced by the first solution to be tested, and the second region B₂ represents a signal intensity value produced by the second solution to be tested.

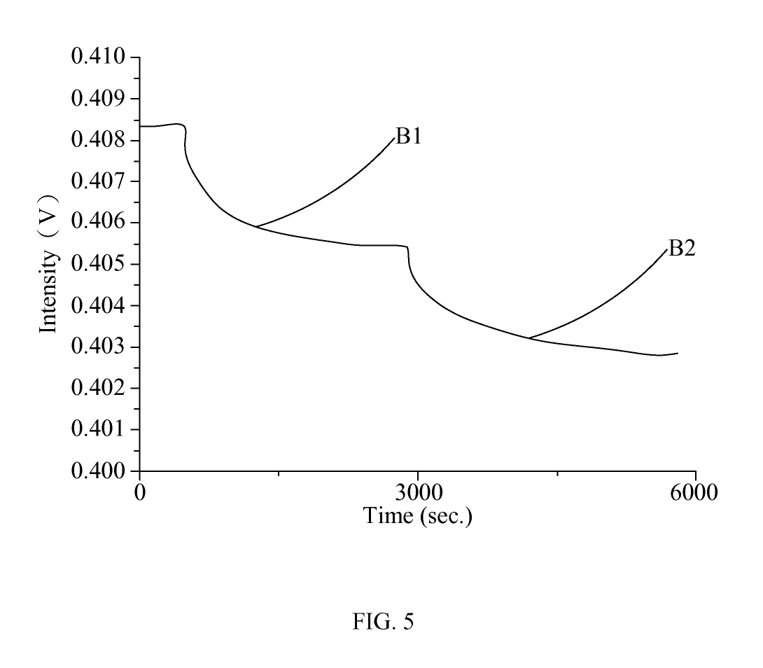

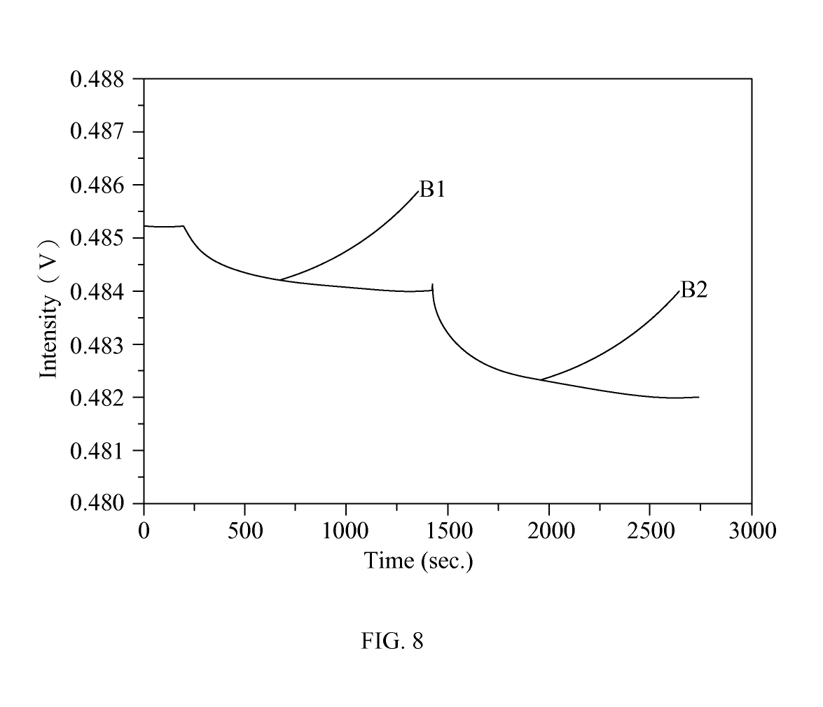

Step 500: Obtain the signal intensity values (I₁), (I₂) of the first region B₁ and the second region B₂ corresponding to the initial time of a reaction in the graph, respectively. In the first region B₁ and the second region B₂, signal intensity values (I_{eq1}), (I_{eq2}) and a reference light signal intensity (I₀) are obtained when the reaction reaches a dynamic balance. Refer to FIG. 5 or 8 for the graph.

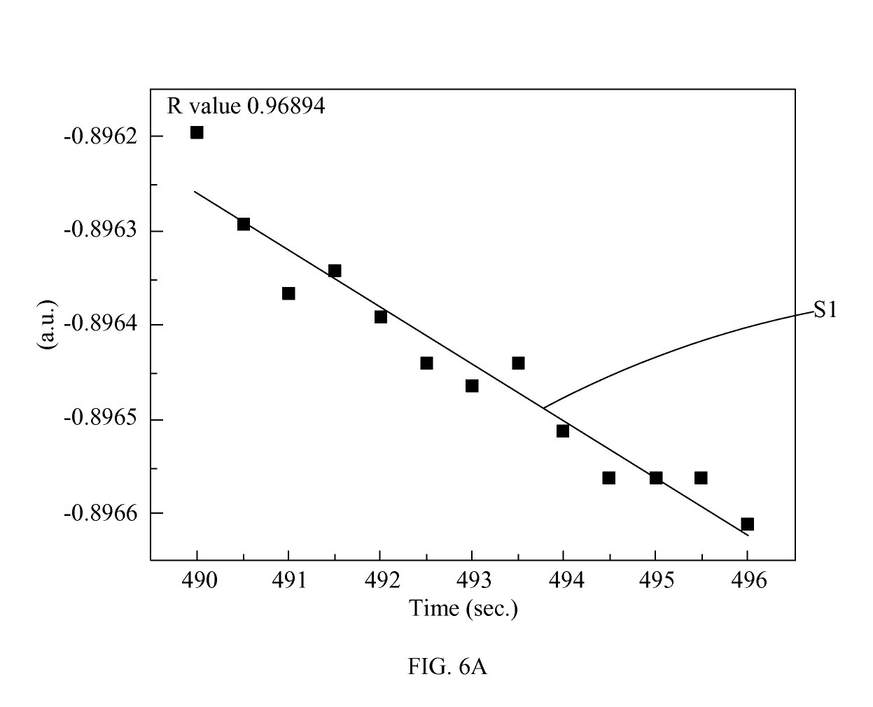

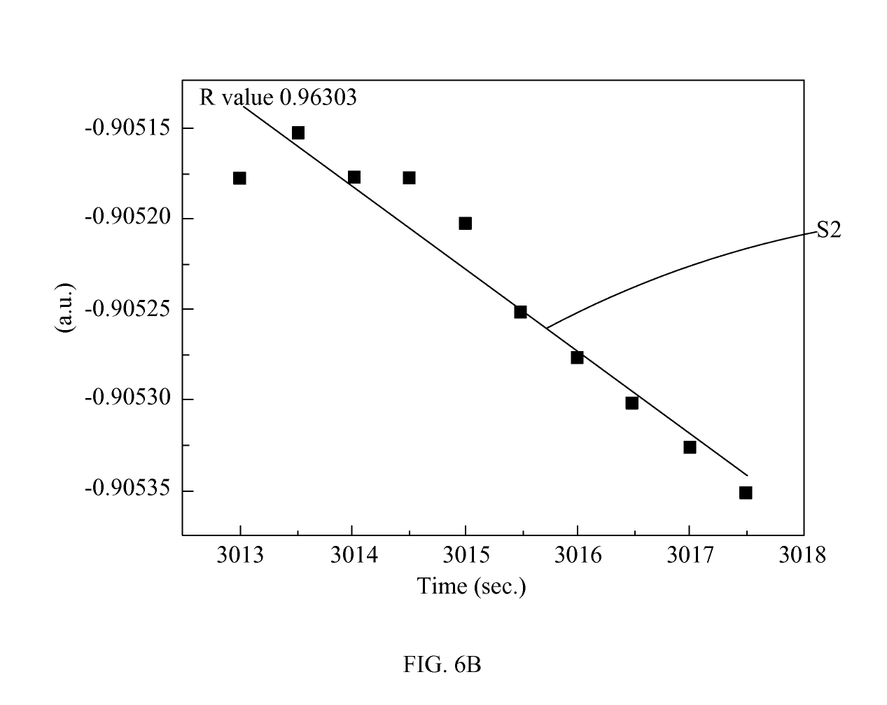

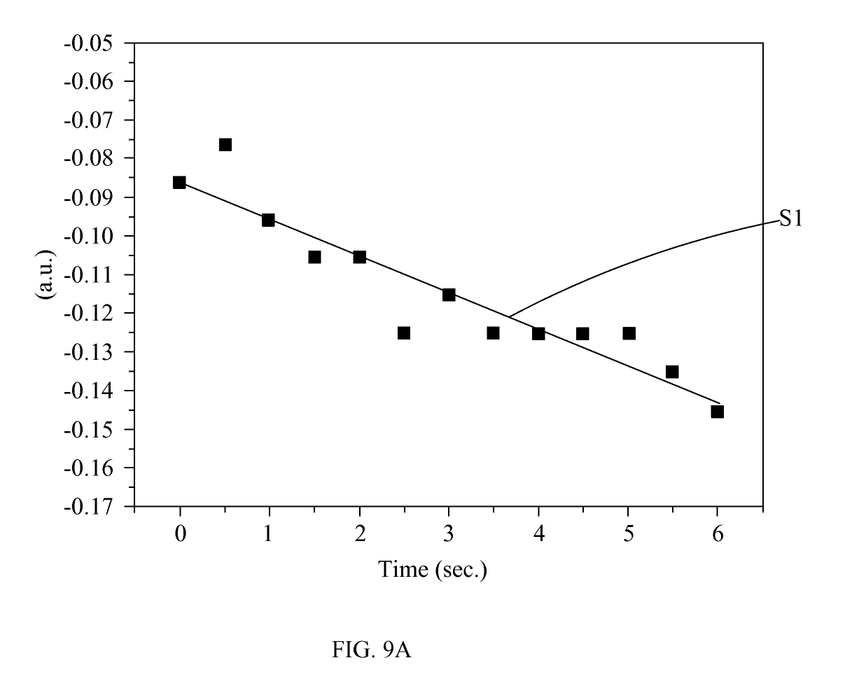

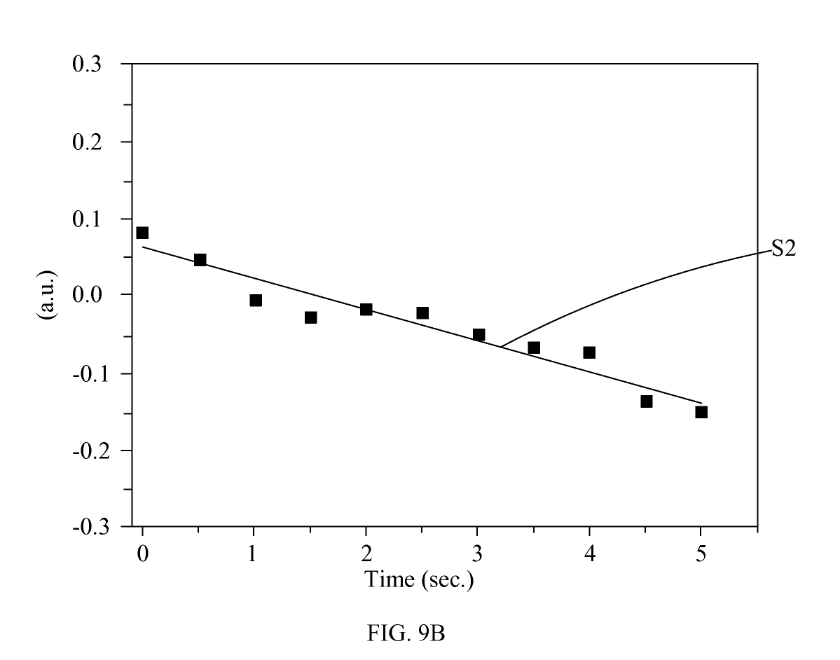

Step 600: Substitute the signal intensity value obtained at the initial time after the first or second solution to be tested is filled up into the first tube and the solution is at a steady state into a formula derived by a pseudo-first order reaction rate equation model and the formula ln [(Iₜ−I_{eq})/(I₀−I_{eq})] is a fractional function of the signal intensity value with respect to a semi-log linear relation of time used for calculating a plurality of fractional logarithm values, and the fractional logarithm values are used for performing a linear regression of time to obtain a first linear graph corresponding to the first region B₁ and a second linear graph corresponding to the second region B₂. Refer to FIG. 6A or 9A for the first linear graph, and FIG. 6B or 9B for the second linear graph.

Step 700: Obtain a first slope (S₁) of the straight line in the first linear graph and a second slope (S₂) of the straight line in the second linear graph.

Step 800: Substitute the first slope (S₁), the second slope (S₂), the first concentration C₁ and the second concentration C₂ into the equation kₐC₁+k_{d}=S₁ and the equation kₐC₂+k_{d}=S₂ to calculate a binding rate constant (kₐ).

Step 900: Substitute the calculated binding rate constant (kₐ) into a formula K_{f}/kₐ to calculate a decomposition rate constant (k_{d}).

With reference to FIG. 5 for a graph of using OVA as a testing layer and anti-OVA as a solution to be tested for a method of estimating binding kinetic rate constants in accordance with the present invention, the curve in the graph is divided into a first region B₁ and second region B₂. The signal intensity values (I₁), (I₂) corresponding to the initial time of a reaction of the first region B₁ and the second region B₂ in the graph, and the signal intensity values (I_{eq1}), (I_{eq2}) and the reference light signal intensity (I₀) when the reaction in the first region B₁ and the second region B₂ reaches a dynamic balance are obtained respectively.

With reference to FIGS. 6A and 6B for the first and second linear graphs obtained by using OVA as a testing layer and anti-OVA as a solution to be tested for the method of estimating binding kinetic rate constants in accordance with the present invention respectively, the obtained signal intensity values is substituted into the formula ln [(Iₜ−I_{eq})/(I₀−I_{eq})] to calculate a plurality of fractional logarithm values, and the fractional logarithm values are used for performing a linear regression of time to obtain a first linear graph corresponding to the first region B₁ and a second linear graph corresponding to the second region B₂.

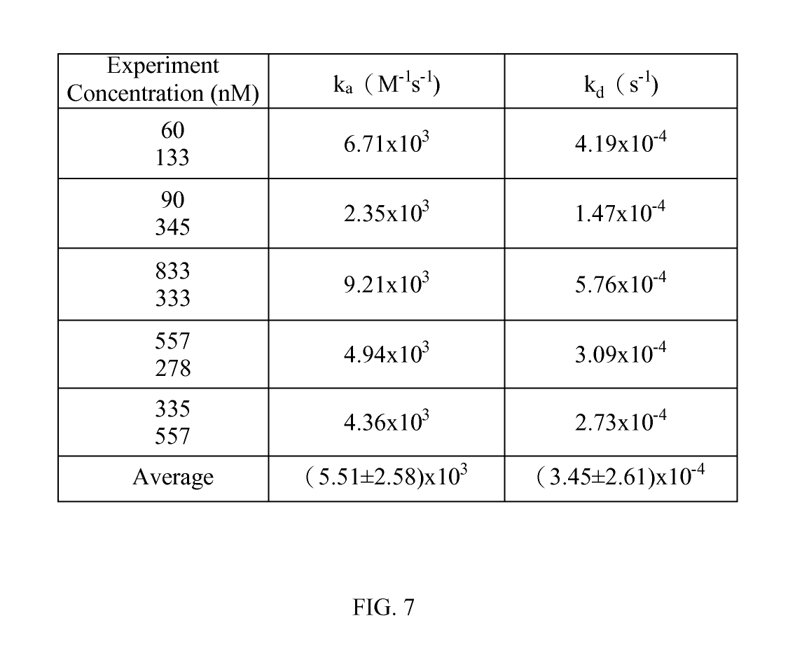

With reference to FIG. 7 for a data chart of binding rate constants (kₐ) and decomposition rate constants (k_{d}) obtained by using OVA as a testing layer and anti-OVA as a solution to be tested in a method for estimating binding kinetic rate constants in accordance with the present invention, the present invention can indeed estimate the binding rate constant (kₐ) and the decomposition rate constant (k_{d}) by using the OVA and the anti-OVA for the reaction.

With reference to FIG. 8 for a graph of a method that uses a mouse IgG as a testing layer and an anti-mouse IgG as a solution to be tested to estimate binding kinetic rate constants in accordance with the present invention, the curve in the graph is divided into a first region B₁ and a second region B₂. The signal intensity values (I₁), (I₂) corresponding to the initial time of a reaction of the first region B₁ and the second region B₂ in the graph, and the signal intensity values (I_{eq1}), (I_{eq2}) and the reference light signal intensity (I₀) when the reaction in the first region B₁ and the second region B₂ reaches a dynamic balance are obtained respectively.

With reference to FIGS. 9A and 9B for the first and second linear graphs of a method that uses a mouse IgG as a testing layer and an anti-mouse IgG as a solution to be tested to estimate binding kinetic rate constants in accordance with the present invention respectively, the obtained signal intensity values are substituted into the formula ln [(Iₜ−I_{eq})/(I₀−I_{eq})] to calculate a plurality of fractional logarithm values, and the fractional logarithm values are used for performing a linear regression of time to obtain a first linear graph corresponding to the first region B₁ and a second linear graph corresponding to the second region B₂.

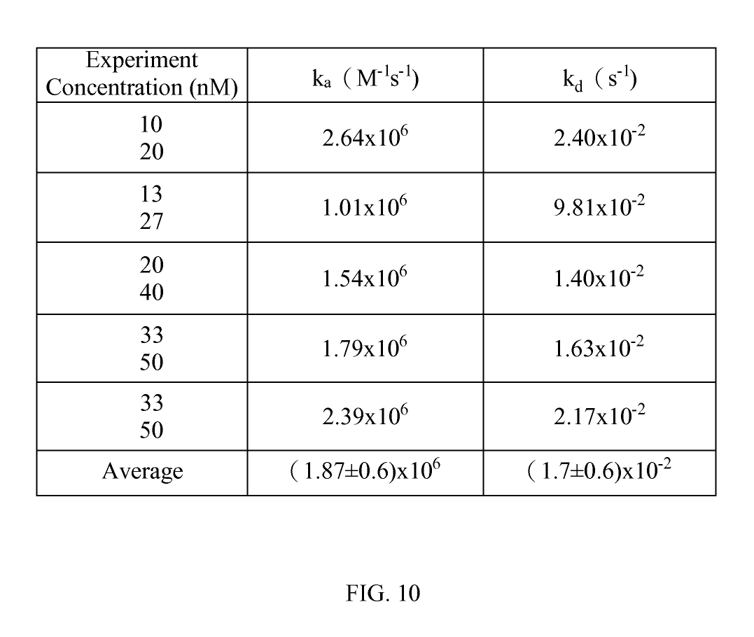

With reference to FIG. 10 for a data chart of the binding rate constants (kₐ) and the decomposition rate constants (k_{d}) obtained by using a method that uses a mouse IgG as a testing layer and an anti-mouse IgG as a solution to be tested to estimate binding kinetic rate constants in accordance with the present invention, the present invention can indeed estimate the binding rate constant (kₐ) and the decomposition rate constant (k_{d}) by using the mouse IgG and the anti-mouse IgG for the reaction.

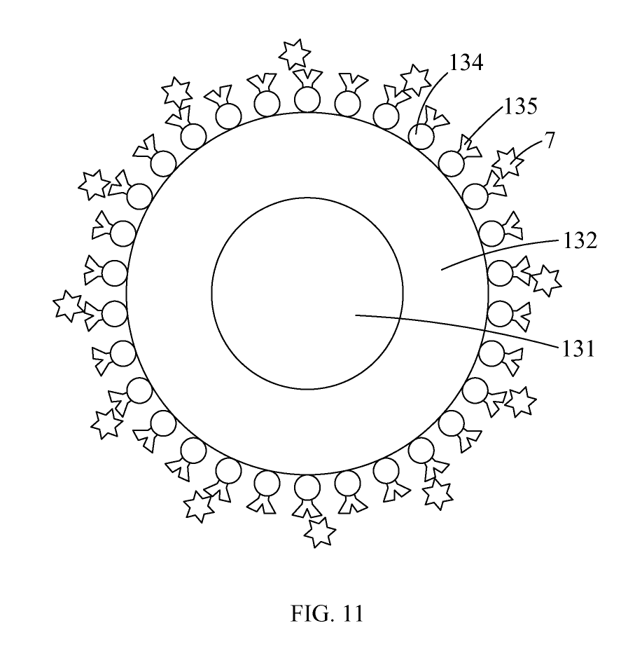

With reference to FIG. 11 for a schematic view of a performing a binding action of a solution to be tested and a testing layer, it is noteworthy that when the substance to be tested 7 in the solution to be tested is bounded with the testing layer 135, the nanoparticle layer 134 has a particle plasmon resonance due to the binding reaction, and the particle plasmon resonance further produces a change of the signal intensity value. Accordingly, the change of signal intensity values can be measured to estimate the kinetics constants.

It is noteworthy that if the nanoparticle layer 134 is excited by the light, an extinction spectrum will be produced, and the extinction spectrum is called a particle plasmon resonance (PPR) band. The basic sensing principle of the particle plasmon resonance sensing system resides on that when the nanoparticle layer 134 detects a change of the index of refraction in an environment, the particle plasmon resonance band will have a change in peak value, wavelength and extinction cross-section. In a waveguide phenomenon, the light of a specific frequency will have an effect with the PPR phenomenon of the nanoparticle layer 134 at the reflective interface each time. The larger the number of times of the reflection, the larger is the number of times of full internal reflection of the incident light, so that the light exited from the optical fiber becomes weaker. In summation, the full internal reflection can accumulate the variances of the PPR signals to achieve the effect of improving the testing sensitivity.

It is noteworthy to point out that the first and second solutions to be tested are filled up in the first tube and then the solutions will reach a steady state; and the time for filling up the solution to be tested in the first tube must be much smaller than the time for a dispersing solute to be tested around the corners of the first tube to in contact with the molecules of a probe on the testing layer via diffusion. The standard for setting the filling time is given below: The injection time must be smaller than half of the time for receiving a light with the intensity I to reach the value of the equation [(Iₜ−I_{eq})/(I₀−I_{eq})] is equal to 0.4, wherein I₀ and I_{eq} are the light intensity signal of the reference solution and the light intensity signal at the dynamic balance respectively. However, the solution to be tested is at a non-steady state when it is filled into the first tube, and the light intensity signal and the ratio [(Iₜ−I_{eq})/(I₀−I_{eq})] are greater than those in the neighborhood of 0.4, and thus the results are not adopted. With the assumption of the pseudo-first order reaction rate equation, the complex concentration varies with time, which is equal to the binding rate of the solute to be tested and the testing layer minus the complex decomposition rate. If the complex concentration is directly proportional to the light signal intensity, we can derive that the log value of [(Iₜ−I_{eq})/(I₀−I_{eq})] and the time have a linear relation. In FIG. 6A or 9A, a final signal value is selected from the first region B₁ and the second region B₂ and substituted into the formula [(Iₜ−I_{eq})/(I₀−I_{eq})], and the ratio is equal to 0.1 which is smaller than the reference value 0.4.

In summation of the description above, the method for estimating binding kinetic rate constants by using a fiber optics particle plasmon resonance sensor in accordance with the present invention at least has the following advantages:

The method for estimating binding kinetic rate constants by using a fiber optics particle plasmon resonance sensor in accordance with the present invention simply requires filling the first solution to be tested and the second solution to be tested from the first opening into the first tube, and then obtaining the signal intensity values (I₁), (I₂) corresponding to the initial time of the reaction of the first region and second region in the graph, the signal intensity values (I_{eq1}), (I_{eq2}) and the reference light signal intensity (I₀) in the first region and the second region when the dynamic balance is reached so as to estimate the binding rate constant (kₐ) and the decomposition rate constant (k_{d}) simply.

The present invention requires no fluorophore labeling mechanism for labeling the substance to be tested, and thus will not affect the properties of the substance to be tested.

In summation of the description above, the present invention breaks through the prior, achieves the expected effects, and complies with the patent application requirements, and thus is duly filed for patent application.

While the invention has been described by means of specific embodiments, numerous modifications and variations could be made thereto by those skilled in the art without departing from the scope and spirit of the invention set forth in the claims.

1. A method for estimating binding kinetic rate constants by using a fiber optics particle plasmon resonance (FOPPR) sensor, comprising the steps of:
providing the fiber optics particle plasmon resonance sensor that comprises:
a light source for emitting a light;
a light receiver; and
an optical-fiber sensor chip disposed between the light source and the light receiver, and comprising:
an optical fiber divided into a first region and a second region, and the first region being disposed on both corresponding opposite sides of the second region, and the first region having a fiber core, a clad and a protective layer arranged sequentially from inside to outside, and the fiber core being made of a material with an index of refraction greater than the index of refraction of the clad, such that the light travels in the fiber core, and the second region having the fiber core, the clad, a nanoparticle layer and a testing layer arranged sequentially from inside to outside;
a first plate having a groove provided for disposing the optical fiber; and
a second plate having a first tube and a second tube longitudinally disposed on a side of the second plate, and the first tube being hollow and having a first opening, and the second tube being hollow and having a second opening, and the first tube and the second tube interconnected to the second plate, and another side of the second plate different from the side having the first tube and the second tube corresponding to the first plate face to face with each other, such that the optical fiber is disposed between the first plate and the second plate, and the optical fiber is disposed correspondingly in the groove of the first plate, and the second plate is disposed corresponding to the first plate face to face with each other and packaged;
turning on the light source of the FOPPR sensor, so that the light enters into the optical fiber of the optical-fiber sensor chip, and the light is fully reflected to travel in the fiber core, and the light receiver of the fiber optics particle plasmon resonance sensor starts receiving a light signal;
filling a reference solution quickly into the first tube from the first opening that serves as an inlet;
filling a first solution to be tested into the first tube from the first opening that serves as an inlet, such that the first solution to be tested flows from the first tube into the optical-fiber sensor chip, and the first solution to be tested having a first concentration C₁;
filling a second solution to be tested into the first tube from the first opening that serves as an inlet, such that the second solution to be tested flows from the first tube into the optical-fiber sensor chip, and the second solution to be tested having a second concentration C₂;
converting the light signal received by the light receiver into a signal intensity value versus time intensity value graph through the fiber optics particle plasmon resonance sensor, and the curve in the graph being divided into a first region and a second region, and the first region having a signal intensity value generated by the first solution to be tested, and the second region having a signal intensity value generated by the second solution to be tested;
obtaining signal intensity values I₁ and I₂ of the first region and the second region corresponding to the initial reaction time from the graph respectively, and signal intensity values I_{eq1} and I_{eq2} and a reference light signal intensity I₀ when the reaction in the first region and the second region reaches a dynamic balance;
substituting the signal intensity value obtained at an initial state after filling up the first solution to be tested or the second solution to be tested in the first tube and at a steady state formula ln [(Iₜ−I_{eq})/(I₀−I_{eq})] to calculate a plurality of fractional logarithm values, and perform a linear regression of the time by using the fractional logarithm values to obtain a first linear graph corresponding to the first region and a second linear graph corresponding to the second region;
obtaining a first slope S₁ of a straight line in the first linear graph and a second slope S₂ of a straight line in the second linear graph; and
substitute the first slope S₁, the second slope S₂, the first concentration C₁ and the second concentration C₂ into a first equation kₐC₁+k_{d}=S₁ and a second equation kₐC₂+k_{d}=S₂ to obtain a binding rate constant kₐ by the first equation and the second equation.

2. The method for estimating binding kinetic rate constants by using a fiber optics particle plasmon resonance sensor as recited in claim 1, wherein the light source is a single-frequency light or a narrowband light.

3. The method for estimating binding kinetic rate constants by using a fiber optics particle plasmon resonance sensor as recited in claim 1, wherein the first plate or the second plate is a plastic plate.

4. The method for estimating binding kinetic rate constants by using a fiber optics particle plasmon resonance sensor as recited in claim 1, wherein the fiber core is made of silicon dioxide, and the clad is made of a polymer material.

5. The method for estimating binding kinetic rate constants by using a fiber optics particle plasmon resonance sensor as recited in claim 1, wherein the testing layer is an antibody, an antigen, a lectin, a hormone receptor, a nucleic acid or a saccharide.

6. The method for estimating binding kinetic rate constants by using a fiber optics particle plasmon resonance sensor as recited in claim 1, wherein the nanoparticle layer is made of nano gold or nano silver.

7. The method for estimating binding kinetic rate constants by using a fiber optics particle plasmon resonance sensor as recited in claim 1, wherein the nanoparticle layer is comprised of a plurality of noble metal nanospheres, a plurality of noble metal nanotubes or a plurality of noble metal nanoshells.

8. The method for estimating binding kinetic rate constants by using a fiber optics particle plasmon resonance sensor as recited in claim 1, wherein the fiber optics particle plasmon resonance sensor further comprises:
a signal waveform generator installed on a side different from a side having the optical-fiber sensor chip of the light source, and provided for generating a square wave of a constant frequency to the light source;
a lock-in amplifier installed on a side different from a side having the optical-fiber sensor chip of the light receiver, and the signal waveform generator generating a reference signal to the lock-in amplifier, and the lock-in amplifier receiving the light signal from the light receiver, and processing the light signal and the reference signal to generate a processed signal; and
a computer, installed on a side different from a side having the light receiver of the lock-in amplifier, and provided for receiving the processed signal from the lock-in amplifier, and displaying the processed signal for reading.

9. The method for estimating binding kinetic rate constants by using a fiber optics particle plasmon resonance sensor as recited in claim 1, wherein the second concentration C₂ is greater than the first concentration C₁.

10. The method for estimating binding kinetic rate constants by using a fiber optics particle plasmon resonance sensor as recited in claim 1, further comprising the step of substituting the obtained binding rate constant kₐ into a formula k_{f}/kₐ to obtain a decomposition rate constant k_{d} after the binding rate constant kₐ is obtained.
